(19) United States
(12) Patent Application Publication
(10) Pub. No.: US 2023/0416576 A1
(43) Pub. Date: Dec. 28, 2023

(54) ADHESIVE ADDITIVE FOR ELECTRICAL CONDUCTIVITY AND METHODS FOR MANUFACTURING THE SAME

(71) Applicant: Rivian IP Holdings, LLC, Irvine, CA (US)

(72) Inventor: Timothy E. Knight, Tomahawk, WI (US)

(21) Appl. No.: 17/847,503

(22) Filed: Jun. 23, 2022

(51) Int. Cl. C09J 9/02; C25D 15/00; C09J 5/00; C09J 7/30

(52) U.S. Cl. CPC C09J 9/02; C25D 15/00; C09J 5/00; C09J 7/30; C09J 2203/326; C09J 2301/314; C09J 2400/16; B62D 29/00

(57) ABSTRACT

Systems and methods are described herein for providing electrical conductivity between a first member including a first metal material having a first galvanic potential and a second member including a second metal material having a second galvanic potential during electrocoating. An adhesive comprising conductive metallic particles is applied to one of the first or the second members. The first member and the second member are joined via the particle-induced adhesive, wherein the particle-induced adhesive provides electrical conductivity between the first member and the second member when the first member and the second member are joined.

### INTRODUCTION

In the manufacturing and coating of vehicle components, electrical conductivity is an important part for coating components defect-free. For example, performing an electrodeposition process, also called an electrocoating process, can be used, where a component without proper electrical conductivity may cause arc through (i.e., a defect in the appearance of a weld). The electrocoating process functions by applying voltage an electric current between the components and a counter-electrode in electrical contact until the desired coating is deposited on the component. When the vehicle component (e.g., panel) is not connected to a lead wire to provide the appropriate ground, an arc through the component may occur. The severity of the arc through the component may further be based on the materials of the component. For example, an aluminum component (e.g., a panel) near a magnesium panel may lead to more severe defects. That is, when running the poorly grounded vehicle component (e.g., aluminum panel) through the electrocoating process, the component becomes a floating ground, which causes either no coating on the outer component or an arc through the component (i.e., a welding point at the arc location). Consequently, what is needed is an improved way to maintain electrical continuity through a component while undergoing any electrodeposition process.

### SUMMARY

Accordingly, systems and methods are disclosed herein to provide consistent uniform electrical contact between the various vehicle components during electrocoating. For example, providing an adhesive having certain conductive properties (e.g., zinc particles) between a first member (e.g., magnesium inner panel) and a second member (e.g., aluminum outer panel) provides electrical conductivity between a first member and a second member. In some embodiments, the vehicle components correspond to a door for a vehicle storage compartment.

In some embodiments, the system includes an adhesive dispersal module configured to apply a particle-induced adhesive on at least one of the first member and the second member. The system further joins the first member and the second member via the particle-induced adhesive. The particle-induced adhesive includes conductive metallic particles and provides electrical conductivity between the first member and the second member. In some embodiments, the system further performs electrocoating on the first member and the second member. In some embodiments, the particle-induced adhesive, between the first member and the second member, enhances uniform adhesive for bond consistency without “squeeze out” while also providing electrical continuity through the adhesive joints.

In some embodiments, the particle-induced adhesive contains conductive metallic particles having a size in the range of 200-2000 micrometers. In some embodiments, a concentration of conductive metallic particles within the particle-induced adhesive is in a range of 0.01-30.0 weight percent (wt. %). In some embodiments, the particle-induced adhesive includes one or more of a thermal adhesive, a high strength adhesive, a UV adhesive, or a combination thereof and conductive metallic particles blended therein.

In some embodiments, to create the particle-induced adhesive, the system applies on at least one of the first member and the second member one or more adhesives and then further applies conductive metallic particles on an exterior of the applied one or more adhesives. In some embodiments, the conductive metallic particles dispersed in the particle-induced adhesive are configured to provide electrical conductivity between the first member and the second member.

In some embodiments, the conductive metallic particles dispersed in the particle-induced adhesive are uniformly dispersed within the particle-induced adhesive. In some embodiments, the first member includes a first metal material first galvanic potential, the second member includes second metal material a second galvanic potential, and the system is configured to select a type and concentration of conductive metallic particles in the particle-induced adhesive such that a galvanic potential of the particle-induced adhesive is between the first galvanic potential and the second galvanic potential.

In some embodiments, the system applies conductive metallic particles in the particle-induced adhesive by one or more of chemical vapor deposition, spraying, sprinkling, or blending particles into the particle-induced adhesive.

In some embodiments, the disclosure provides for an apparatus including a first member comprising a first metal material (e.g., magnesium) having a first galvanic potential, a second member comprising a second metal material (e.g., aluminum) having a second galvanic potential, a particle-induced adhesive on at least one of the first member and the second member, wherein the first member and the second member are joined via the particle-induced adhesive, wherein the particle-induced adhesive includes conductive metallic particles (e.g., zinc particles) and provides electrical conductivity between the first member and the second member when joined.

### BRIEF DESCRIPTION OF THE FIGURES

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative diagram of a first member joined with a second member by a particle-induced adhesive, in accordance with some embodiments of the present disclosure;

FIG. 2 shows another illustrative diagram of a first member joined with a second member by a particle-induced adhesive, in accordance with some embodiments of the present disclosure;

FIG. 3 shows a side view of a portion of an illustrative vehicle having a storage compartment where the first member and second member are disposed, in accordance with some embodiments of the present disclosure;

FIG. 4 shows a detailed illustrative diagram of a first member joined with a second member by a particle-induced adhesive around a gear tunnel door, in accordance with some embodiments of the present disclosure;

FIG. 5 shows a block diagram of an illustrative system for joining a first member with a second member by a particle-induced adhesive, in accordance with some embodiments of the present disclosure;

FIG. 6 shows a block diagram of an illustrative system for electrocoating the joined first member with a second member by a particle-induced adhesive, in accordance with some embodiments of the present disclosure; and

FIG. 7 shows a flowchart for an exemplary process for making the joined first member with a second member by a particle-induced adhesive for electrocoating, in accordance with some embodiments of the present disclosure.

### DETAILED DESCRIPTION

This disclosure provides, inter alia, novel members joined with an adhesive to provide electrical conductivity between the members. In some embodiments, the system includes a storage chamber configured to store a first member and a second member. The system further includes an adhesive dispersal module configured to an adhesive on at least one of the first member and the second member. The system further joins the first member and the second member via the adhesive. The adhesive includes conductive metallic particles (e.g., a particle-induced adhesive) and provides electrical conductivity between the first member and the second member when the first member and the second member are joined. In some embodiments, the system further performs electrocoating on the first member and the second member. The particle-induced adhesive, between the first member and the second member, enhances uniform adhesive for bond consistency without “squeeze out” while also providing electrical continuity through the adhesive joints.

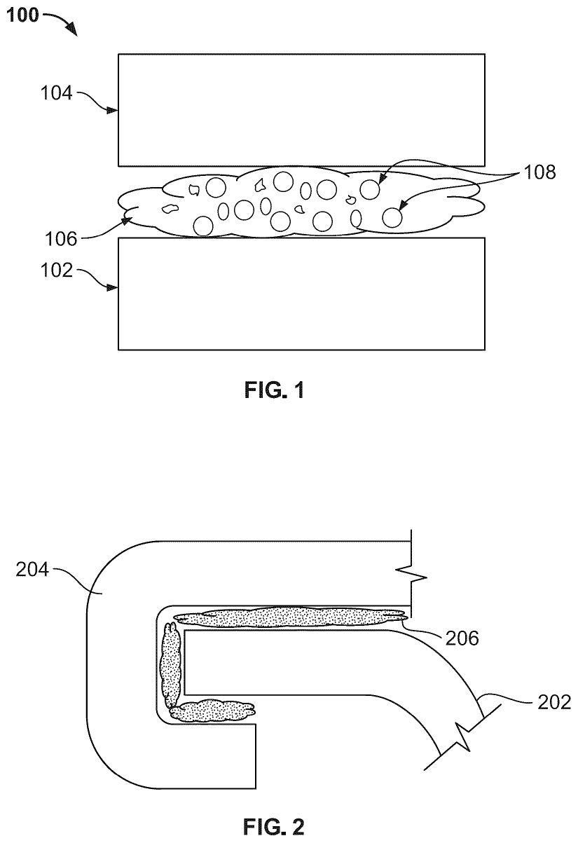

FIG. 1 shows an illustrative diagram 100 of a first member joined with a second member by a particle-induced adhesive, in accordance with some embodiments of the present disclosure. FIG. 1 shows a first member 102, an adhesive 106 with conductive metallic particles 108 dispersed in the adhesive 106, and a second member 104. In some embodiments, the first member 102 comprises a first metal material having a first galvanic potential and the second member 104 comprises a second metal material having a second galvanic potential. In some embodiments, the first metal material is magnesium or magnesium alloy and the second metal material is aluminum or aluminum alloy. The adhesive 106 is configured to include conductive metallic particles. In some embodiments, the galvanic potential of the adhesive 106 including the conductive metallic particles is between the first galvanic potential and the second galvanic potential. For example, if the first metal material is magnesium or magnesium alloy and the second metal material is aluminum or aluminum alloy, the conductive metallic particles may be zinc (e.g., a zinc-induced adhesive). The adhesive 106 is positioned between and in contact with the first and second members 102, 104. The thickness of the adhesive 106 between the first member 102 and the second member 104 may vary from section to section. The thickness of the adhesive 106 may be in a range between 1-10,000 micrometers (μm). The thickness of the adhesive 106 may be varied based on the requirements of a particular application to ensure reliable bonding between the first and second members 102, 104. The conductive metallic particles dispersed in the adhesive 106 provide electrical conductivity between the second member 104 and the first member 102. Accordingly, during electrocoating, or any process where a voltage is applied, the two joined members (e.g., first magnesium member 102 and second aluminum member 104) maintain electrical conductivity throughout.

The conductive metallic particles 108 dispersed in the adhesive 106 may include a particle size in the range of 200-2,000 micrometers (μm). A concentration of conductive metallic particles 108 in the particle-induced adhesive may be in a range of 0.01-30.0 weight percent (wt. %). In some embodiments, as shown in FIG. 1, shapes of the conductive metallic particles 108 may range from spheres to irregular and granular metallic, such that when the first member 102 and the second member 104 are joined, the conductive metallic particles 108 provide electrical conductivity between the first member 102 and the second member 104. Additionally, in some embodiments, the thickness of the adhesive 106 when the first member 102 and the second member 104 are joined may be varied by varying the size of the conductive metallic particles 108. The adhesive 106 may include one or more of a thermal adhesive, a high strength adhesive, a UV adhesive, or a combination thereof and conductive metallic particles blended therein. In some embodiments, to create the particle-induced adhesive, the system applies conductive metallic particles 108 on an exterior of the applied one or more adhesives 106.

In some embodiments, the conductive metallic particles dispersed in the particle-induced adhesive are uniformly dispersed within the particle-induced adhesive. In some embodiments, the first member includes a first galvanic potential, the second member includes a second galvanic potential, and the system is configured to select a concentration and type of conductive metallic particles in the particle-induced adhesive such that a galvanic potential of the particle-induced adhesive is between the first galvanic potential and the second galvanic potential. In the particle-induced adhesive, the conductive metallic particles are used as a conductive pigment to produce an anodically active coating. For example, when the first member magnesium, the second member is aluminum, and the conductive metallic particles are zinc, the conductive metallic particles (e.g., zinc) provide a transfer of galvanic current through the adhesive from the second member (e.g., aluminum panel) to the first member (e.g., magnesium panel). The aluminum panel remains galvanically protected by the zinc-induced adhesive by providing the electron-conducting pathways in the system, and there is sufficient zinc to act as the anode. Without compromising the strength of the adhesive, additional additives may be added to the particle-induced adhesives to maintain the functionality. For example, as more conductive metallic particles are dispersed in the adhesive, the viscosity of the adhesive increases, thereby making it more difficult to apply on one of first or second members; accordingly, additives may be added to the adhesive (solvents, emulsifiers, etc.) to improve the functionality. In some embodiments, the system includes the pretreatment of the particle-induced adhesives to prepare for application. For example, a heater may be used to heat the adhesive 106, while a mixer or a sonifier may be used to agitate the adhesive to distribute the conductive metallic particles 108 uniformly.

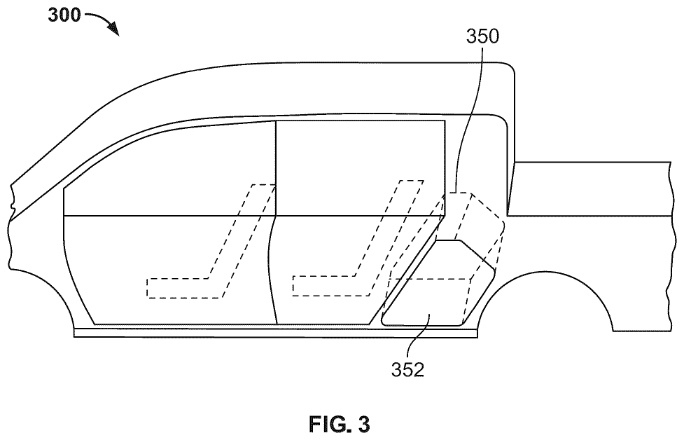

FIG. 2 shows another illustrative diagram of a first member joined with a second member by a particle-induced adhesive, in accordance with some embodiments of the present disclosure. It should be noted that FIG. 2 shows a first member 202, an adhesive 206 with conductive metallic particles dispersed in the adhesive 206, and a second member 204, with a similar configuration of FIG. 1 discussed above. In one embodiment, the first member 202 comprises magnesium or magnesium alloy, the second member 204 comprises aluminum or aluminum alloy, and the conductive metallic particles are zinc. In another embodiment, the first member 202 comprises magnesium or magnesium alloy, the second member 204 comprises titanium or titanium alloy, and the conductive metallic particles comprise aluminum. The second member 204 illustrates the folded edge of the second member over the flat or nearly flat edge of the first member 202. The first member 202 does not contact the second member 204 with the adhesive 206 surrounding the contact area with the second member 204.

FIG. 3 shows a side view of a portion of an illustrative vehicle having the joined members disposed therein, in accordance with some embodiments of the present disclosure. Vehicle 300 includes storage compartment 350 having a volume and opening 352 to the exterior of vehicle 300. In some embodiments, storage compartment 350 may be referred to as a gear tunnel door. The user may open a hatch or door (e.g., a gear tunnel door not shown) at opening 352 to obtain access to the inside of storage compartment 350. In some embodiments, the door that closes storage compartment 350 may include a particle-induced adhesive between the exterior panel (e.g., second member) and the interior panel (e.g., first member) to provide electrical conductivity. In one embodiment, the exterior panel on the door may be aluminum, the interior panel may be magnesium, and the particle-induced adhesive may include zinc particles. In some embodiments, storage compartment 350 may have a first opening on the left side of the vehicle 300, and a second opening on the right side of the vehicle (e.g., opening 352 is one of the openings, with the other on the opposite side of vehicle 300). In some embodiments, any fixed or movable component on the vehicle, e.g., a door, a hood, a cover, or quarter panel, may include a conductive adhesive to provide adequate electrical conductivity between components or panels.

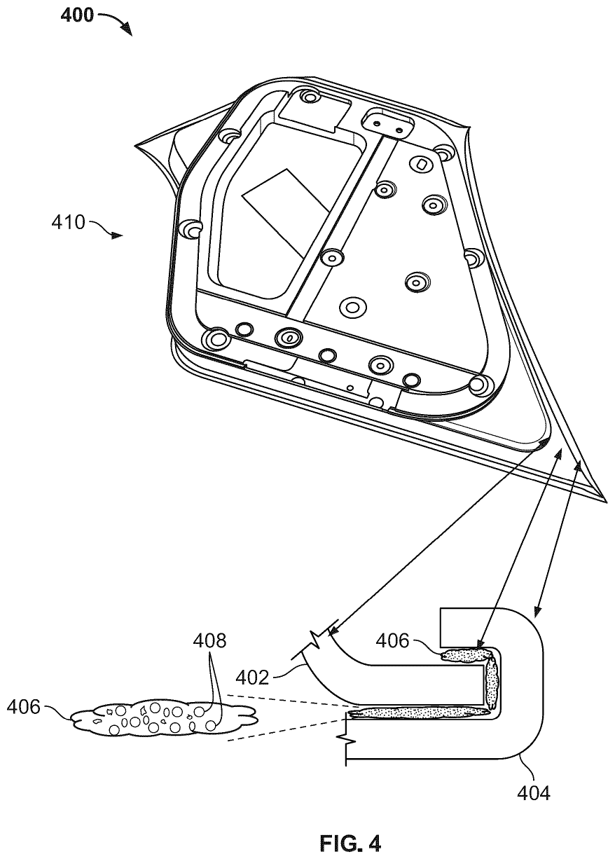

FIG. 4 shows a detailed illustrative diagram of a first member joined with a second member by a particle-induced adhesive around a gear tunnel door, in accordance with some embodiments of the present disclosure. It should be noted that FIG. 4 shows a first member 402, an adhesive 406 with conductive metallic particles 408 dispersed in the adhesive 406, and a second member 404, with a similar configuration of FIGS. 1 and 2 discussed above. The first member 402 comprises magnesium or magnesium alloy. The second member 404 comprises aluminum or aluminum alloy. In one embodiment, the first member 402 comprises magnesium or magnesium alloy, the second member 404 comprises aluminum or aluminum alloy, and the conductive metallic particles are zinc. In another embodiment, the first member 402 comprises magnesium or magnesium alloy, the second member 404 comprises titanium or titanium alloy, and the conductive metallic particles comprise aluminum. The second member 404 illustrates the folded edge of the second member over the flat or nearly flat edge of the first member 402. The adhesive 406 includes conductive metallic particles 408 dispersed in the adhesive 406. In some embodiments, the conductive metallic particles dispersed in the particle-induced adhesive are uniformly dispersed within the particle-induced adhesive. In some embodiments, the first member 402 includes a first galvanic potential, the second member 404 includes a second galvanic potential, and the system is configured to select a type and concentration of conductive metallic particles in the particle-induced adhesive 406 such that a galvanic potential of the particle-induced adhesive is between the first galvanic potential and the second galvanic potential, as described in greater detail above

In some embodiments, the diagram of a first member 402 joined with a second member 404 by a particle-induced adhesive 406 comprising zinc particles is an illustrative example of a bond on the gear tunnel door 410 with an aluminum panel (exterior panel) and a magnesium panel (interior panel).

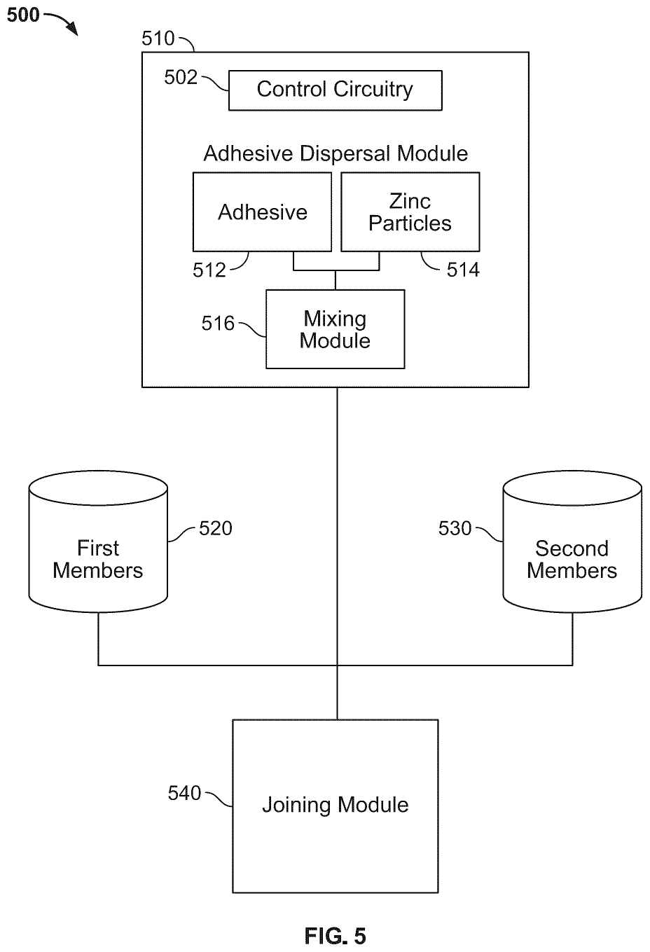

FIG. 5 shows a block diagram of an illustrative system 500 for joining a first member with a second member by a particle-induced adhesive, in accordance with some embodiments of the present disclosure. FIG. 5 depicts an adhesive dispersal module 510, storage for a first member 520, storage for a second member 530, and a joining module 540. In some embodiments, the joining of the members and the applying of the adhesive may be performed automatically or manually. In some embodiments, the adhesive dispersal modules, the storage of the first and second members 520, 530, and the joining module 540 may communicate with all other elements of the system 500. In some embodiments, control circuitry 502 may be included to control all of the different elements of the system 500.

Adhesive dispersal module 510 is responsible for applying adhesive on a surface of one of the first member or the second member. In some embodiments, the adhesive dispersal module 510 applies adhesive to the surface of both the first member and the second member. Adhesive dispersal module 510 includes adhesive 512 and conductive metallic particles 514. In some embodiments, the conductive metallic particles may be colored or transparent. In some embodiments, the conductive metallic particles may contain fluorescent components that may be illuminated by a certain wavelength of light (e.g., UV light). Mixing module 516 is responsible for mixing the adhesive and conductive metallic particles together. In some embodiments, the conductive metallic particles are sprinkled into the adhesive and mixed using a sonifier that transmits sound waves to mix the adhesive. Mixing module 516 may be configured to mix a predetermined portion of adhesive 512 with a fixed quantity of conductive metallic particles 514. In some embodiments, the amount of adhesive 512 and conductive metallic particles 514 to be mixed together, may be programmed by the user using control circuitry 502. In some embodiments, the amount of adhesive 512 and conductive metallic particles 514 to be mixed together, may be modified based on the desired thickness of the adhesive between the first member and the second member. In some embodiments, the shape and size of the conductive metallic particles 514 may be modified based on the desired thickness of the adhesive between the first member and the second member. In some embodiments, the number of conductive metallic particles and adhesive to be mixed, may be based on an adhesive strength of the mixed adhesive 512. In yet another embodiment, the number of conductive metallic particles and adhesive to be mixed, may be based on the galvanic potential. In some embodiments, the adhesive is a two-part adhesive (e.g., a resin and a hardener) and conductive metallic particles 514 are included in one of the two parts. In such embodiments, mixing module 516 mixes the resin and hardener together and, as a result, also mixes conductive metallic particles 514 in the adhesive. In some embodiments, the conductive metallic particles 514 are sprinkled on a contact point on the first member and on the contact point on the second member with the adhesive 512 applied between the two contact points.

Adhesive dispersal module 510 may also include auxiliary sensors. In some embodiments, auxiliary sensors may keep track of a correct positioning of a surface before applying adhesive. For example, auxiliary sensors may include sensors that record a conveyor belt that carries multiple components to be placed under adhesive dispersal module 510 for adhesive to be applied. In this example, auxiliary sensors may include a motion sensor, and only when control circuitry 502 receives an indication from the auxiliary sensors that the conveyor belt carrying the first member has come to a complete halt, will control circuitry 502 instruct adhesive dispersal module 510 to apply the particle-induced adhesive on a surface of a first member or the second member. In some embodiments, auxiliary sensors may include sensors that keep track of quantities of adhesive 512 and conductive metallic particles 514 in adhesive dispersal module 510. In this embodiment, auxiliary sensors may instruct control circuitry 502 to pause the application of adhesive until the adhesive 512 or conductive metallic particles 514 are replenished.

In some embodiments, auxiliary sensors may include sensors that keep track of quantities of first member 520 and second member 530. In this embodiment, auxiliary sensors may instruct control circuitry 502 to pause the application of adhesive until the first member 520 and second member 530 are replenished. Similarly, auxiliary sensors may include a motion sensor, and only when control circuitry 502 receives an indication from the auxiliary sensors that the conveyor belt carrying the first member, the second member and the adhesive has been applied, will control circuitry 502 instructs joining module 540 to join the first member with the second member. For example, one member may be fixed on a work surface or in a clamp and the other member may be positioned using a robotic arm to be joined. As another example, both pieces may be manipulated and joined by respective robotic arms. In addition, a press may be used to fold the edge of one member over or around edge of the other member. In some embodiments, the first member is placed into position on the second member and the edge of the second member is folded over to join the first member in place.

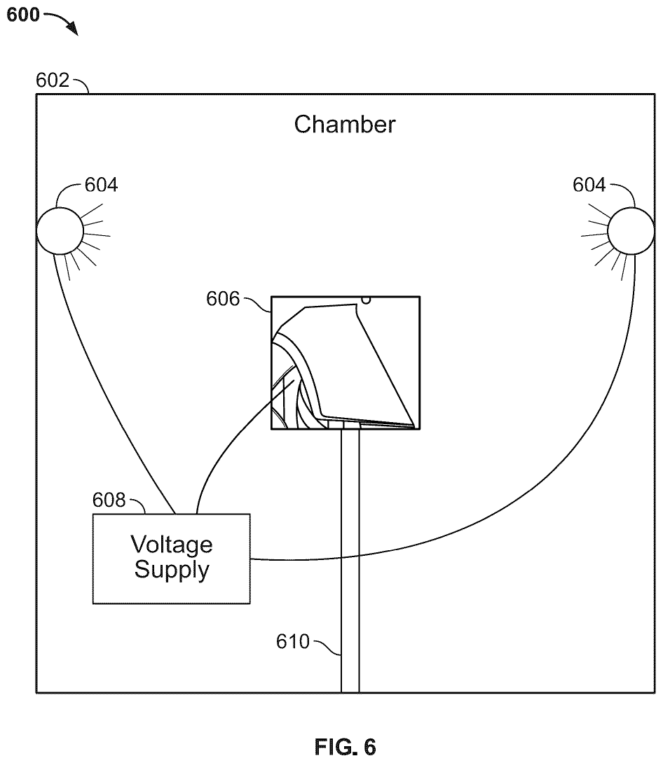

FIG. 6 shows a block diagram of an illustrative system 600 for electrocoating the joined first member with a second member by a particle-induced adhesive, in accordance with some embodiments of the present disclosure. FIG. 6 depicts a chamber 602 with spray nozzles 604, holder 610, the joined members 606 (e.g., first member, particle-induced adhesive and second member), and a voltage supply 608. The chamber 602 is configured for performing the electrocoating of the joined first member and the second member. In some embodiments, the electrocoating is performed using a bath where the joined first and second members are submerged in a solution while under a charge. In some embodiments, the electrocoating is performed using spray nozzles where the coating is sprayed. The spray nozzles 604 are configured to spray a coating onto the joined first member and second members. The joined members 606 include the first member, the second member and the particle-induced adhesive applied on one of the first or second members. The particle-induced adhesive provides contact point for the voltage to travel from the first member to the second member. The voltage supply 608 is configured to supply current to the members 606 and the spray nozzles 604. For example, voltage supply 608 applies a voltage to a first member first member corresponds to first member 102 of FIG. 1, first member 202 of FIG. 2, or first member 402 of FIG. 4 also corresponding to an inner door panel of, for example, the gear tunnel door and that the particle-induced adhesive enables the voltage to pass to the second member corresponding to second member 104 of FIG. 1, second member 204 of FIG. 2, or second member 404 of FIG. 4, the outer door panel of the gear tunnel door to prevent electrical arcs therebetween. In some embodiments, members 606 may correspond to any of the joined members described above, including first member 102 and second member 104 of FIG. 1, first member 202 and second member 204 of FIG. 2, or first member 402 and second member 404 of FIG. 4.

In some embodiments, the holder 610 is configured to hold the joined members in place while electrocoating is performed on the exterior of the first and second members. In some embodiments, members 606 may be electrocoated by itself in the chamber 602. In some embodiments, members 606 may be supported on a portion of a vehicle, for example, on the truck bed and may be electrocoated with the entire body of the vehicle.

In some embodiments, an electrodeposition method and parameters can be employed in carrying out the electrocoating of the joined members. For example, the process of electrocoating can include an electrically conductive substrate (e.g., joined first and second members) submerged into a coating composition bath. Electricity can be applied to the joined members, and the charged particles of the coating can be deposited onto the joined members. As shown, the joined member 606 can enter into the electrocoat bath where a voltage may be applied from a voltage supply 608. Current can be distributed through the joined member 606, and coating may begin to take place. As the deposition continues thickness of the film onto the surface of the joined member 606 increases. Film thickness of the coating can be controlled by manipulating temperature of the bath, amount of voltage applied, or coating deposition time.

The electrocoating process can be used to deposit an adherent film of the electrocoat onto the joined member 606 when a sufficient voltage can be impressed between the electrodes. The applied voltage may be varied and can be, for example, as low as one volt to as high as several thousand volts; typically the voltage can be between 50 and 400 volts. The current density can be between 1.8 ampere and 7.5 amperes per square foot and tends to decrease during electrodeposition, indicating the formation of a coating. The electrocoating process can be used for electro-depositing any number of layers and any kind of layer to the photovoltaic module.

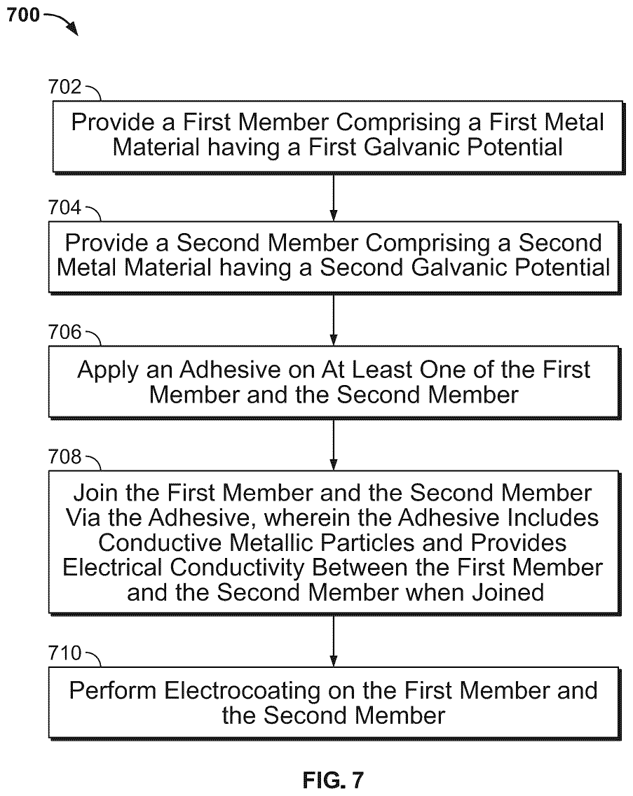

FIG. 7 shows a flowchart for an exemplary process 700 for making the joined first member with a second member by a particle-induced adhesive for electrocoating, in accordance with some embodiments of the present disclosure. It should be noted that process 700 or any step thereof could be performed on, or provided by, the systems of FIG. 5 and FIG. 6. In addition, one or more steps described above may be incorporated into or combined with one or more other steps described herein. Step 702 includes providing a first member comprising a first metal material (e.g., magnesium) having a first galvanic potential. For example, providing a panel for further processing. In some embodiments, the first member corresponds to first member 102 of FIG. 1, first member 202 of FIG. 2, or first member 402 of FIG. 4. In some embodiments, the panel may be pure magnesium or a magnesium alloy. The composition of the first member may be varied based on the desired strength of the first member. The first member may be in any shape, for example, circular, rectangular, irregular share. In some embodiments, providing may include manufacturing the member or retrieving it from inventory. Step 704 includes providing a second member comprising a second metal material (e.g., aluminum) having a second galvanic potential. For example, providing a panel for further processing (e.g., electrocoating). In some embodiments, the second member corresponds to second member 104 of FIG. 1, second member 204 of FIG. 2, or second member 404 of FIG. 4. In some embodiments, the panel may be pure aluminum or an aluminum alloy. In some embodiments, the second member may be in the shape of the first member and further extend past the edges of the first member. In addition, a press may be used to fold the edge of one member over or around edge of the other member. The second member may be configured with edges that fold over the first member. The first member may be in any shape, for example, circular, rectangular, or irregular share. In some embodiments, providing may include manufacturing the member or retrieving it from inventory.

Step 706 includes adhesive dispersal module 510 configured to apply a particle-induced adhesive on at least one of the first member and the second member. In some embodiments, the particle-induced adhesive is applied by the adhesive dispersal module 510 to the edge of the first member. In some embodiments, the particle-induced adhesive corresponds to particle-induced adhesive 106 of FIG. 1, particle-induced adhesive 206 of FIG. 2, or particle-induced adhesive 406 of FIG. 4. In some embodiments, the particle-induced adhesive is applied by adhesive dispersal module 510 to the edge of the second member. The conductive metallic particles in the particle-induced adhesive have a galvanic potential between the first galvanic potential and the second galvanic potential. For example, if the first member comprises magnesium and the second member comprises aluminum, the conductive metallic particles may be zinc particles. In some embodiments, the first member and the second member need to have electrical conductivity, and accordingly, the area around the edge, where the first member and second member join, includes a particle-induced adhesive. In some embodiments, the particle-induced adhesive is positioned by adhesive dispersal module 510 onto the edge and perimeter of the first member. In some embodiments, the conductive metallic particles are applied to the adhesive after the application of the adhesive to the first member. In yet another embodiment, the adhesive is prepared with conductive metallic particles dispersed in the adhesive before applying on one of the first member or the second member and applied on one of the first member or the second member.

Step 708 includes joining the first member and the second member via the particle-induced adhesive, wherein the particle-induced adhesive includes the conductive metallic particles and provides electrical conductivity between the first member and the second member. For example, the first member and the second member are joined by seating the first member into the second member. In another example, the first member is placed into position on the second member and the edge of the second member is folded over to join the first member in place. In some embodiments, the particle-induced adhesive forms a beaded layer between the first member and the second member. In some embodiments, the adhesive layer is disposed around the perimeter of one of the first member or the second member. In some embodiments, the adhesive layer is disposed partially around the perimeter. In some embodiments, the first member and the second member need to have electrical conductivity, and accordingly, the area around the edge, where the first member and second member join, includes a particle-induced adhesive.

Step 710 includes performing electrocoating on the first member and the second member. For example, applying voltage to the first member and the second member until the desired coating is deposited on the first member and the second member. In some embodiments, chamber 602 of FIG. 6 may perform electrocoating on the first member and the second member.

Process 700 may include mixing and positioning the particle-induced adhesive on any suitable members on the vehicle that need electrical conductivity where the two members being joined include members comprising materials having different galvanic potentials (e.g., a magnesium member on one side and an aluminum member on the other side). In some embodiments, a variety of adhesive types may be used to join the two members while maintaining the electrical conductivity using conductive metallic particles in the adhesive. The example of magnesium and aluminum members with a zinc-induced adhesive is provided for purposes of illustration only and that the disclosure can be used with any two materials that are being joined and that need electrical conductivity. In some embodiments, the first member includes a first galvanic potential, the second member includes a second galvanic potential and the adhesive includes additives with a third galvanic potential that is selected to be between the first galvanic potential and the second galvanic potential.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method comprising:
applying an adhesive on at least one of a first member or a second member associated with a component of a vehicle, wherein the first member comprises a first metal material having a first galvanic potential, and the second member comprises a second metal material having a second galvanic potential; and
joining the first member and the second member via the adhesive, wherein the adhesive includes conductive metallic particles and provides electrical conductivity between the first member and the second member when the first member and the second member are joined.

2. The method of claim 1, further comprising performing electrocoating on the joined first and second members.

3. The method of claim 1, wherein a range of size of the conductive metallic particles within the adhesive is 200-2000 micrometers.

4. The method of claim 1, wherein a concentration of the conductive metallic particles within the adhesive is 0.01-10.0 weight percent.

5. The method of claim 1, wherein the adhesive comprises one or more of a thermal adhesive, a high strength adhesive, a UV adhesive, or a combination thereof and the conductive metallic particles blended therein.

6. The method of claim 1, wherein applying the adhesive on at least one of the first member or the second member comprises applying one or more adhesives and applying the conductive metallic particles deposited on an exterior of the applied one or more adhesives.

7. The method of claim 1, wherein the conductive metallic particles are dispersed in the adhesive and are configured to provide electrical conductivity between the first member and the second member.

8. The method of claim 1, wherein the conductive metallic particles have a third galvanic potential, and
wherein the third galvanic potential is between the first galvanic potential and the second galvanic potential.

9. The method of claim 1, wherein the first metal material comprises magnesium, the second metal material comprises aluminum, and the conductive metallic particles comprise zinc particles.

10. The method of claim 1, further comprising:
applying the conductive metallic particles in the adhesive by one or more of chemical vapor deposition, spraying, sprinkling, or blending particles into the adhesive.

11. A system comprising:
an adhesive dispersal module configured to apply adhesive on at least one of a first member comprising a first metal material having a first galvanic potential or a second member comprising a second metal material having a second galvanic potential; and
a joining module configured to join the first member and the second member via the adhesive, wherein the adhesive comprises conductive metallic particles for enabling electrical conductivity between the first member and the second member when the first members and second member are joined.

12. A system of claim 11, further comprising:
a coating chamber configured to perform electrocoating on the joined first and second members.

13. The system of claim 11, wherein a range of size of the conductive metallic particles in the adhesive is 200-2000 micrometers.

14. The system of claim 11, wherein a concentration of the conductive metallic particles within the adhesive is 0.01-10.0 weight percent.

15. The system of claim 11, wherein the adhesive comprises one or more of a thermal adhesive, a high strength adhesive, a UV adhesive, or a combination thereof and the conductive metallic particles blended therein.

16. The system of claim 11, wherein the adhesive dispersal module is configured to apply the adhesive on at least one of the first member or the second member by applying one or more adhesives and applying the conductive metallic particles deposited on an exterior of the applied one or more adhesives.

17. The system of claim 11, wherein the conductive metallic particles are dispersed in the adhesive and are configured to provide electrical conductivity between the first member and the second member.

18. The system of claim 11, wherein the conductive metallic particles in the adhesive are uniformly dispersed within the adhesive, and
wherein the first metal material comprises magnesium, the second metal material comprises aluminum, and the conductive metallic particles comprise zinc particles.

19. The system of claim 11, wherein the adhesive dispersal module is further configured to select a concentration of the conductive metallic particles in the adhesive such that a galvanic potential of the adhesive is between the first galvanic potential and the second galvanic potential.

20. An apparatus comprising:
a first member comprising a first metal material having a first galvanic potential;
a second member comprising a second metal material having a second galvanic potential; and
an adhesive,
wherein the first member and the second member are joined via the adhesive, and wherein the adhesive includes conductive metallic particles and provides electrical conductivity between the first member and the second member when joined.
